(19) United States
(12) Patent Application Publication
(10) Pub. No.: US 2018/0063135 A1
(43) Pub. Date: Mar. 1, 2018

(54) METHOD FOR PERFORMING AUTHENTICATION OF USER EQUIPMENT FOR INDIVIDUAL SERVICES IN WIRELESS COMMUNICATION SYSTEM AND APPARATUS FOR THE SAME

(71) Applicant: LG ELECTRONICS INC., Seoul (KR)

(72) Inventors: Genebeck HAHN, Seoul (KR); Jiwon KANG, Seoul (KR); Heejin KIM, Seoul (KR); Ilmu BYUN, Seoul (KR); Hyunjin SHIM, Seoul (KR); Heejeong CHO, Seoul (KR)

(73) Assignee: LG ELECTRONICS INC., Seoul (KR)

(21) Appl. No.: 15/610,393

(22) Filed: May 31, 2017

Related U.S. Application Data
(60) Provisional application No. 62/344,998, filed on Jun. 3, 2016.
(60) Provisional application No. 62/343,142, filed on May 31, 2016.

(51) Int. Cl. H04L 29/06; H04W 48/16; H04W 48/18; H04W 12/06

(52) U.S. Cl. CPC H04L 63/0876; H04W 48/16; H04W 88/06; H04W 12/06; H04W 48/18

(57) ABSTRACT

A method for performing authentication of a User Equipment (UE) for individual services in a wireless communication system according to the present invention, which is performed by a first network node providing a common control function, comprises receiving from a RAN (Radio Access Network) node a first message with respect to the UE's request to connect to a core network; and transmitting a second message for requesting authentication of the UE's connection request to a specific second network node on the basis of an indicator included in the first message.

### CROSS-REFERENCE TO RELATED APPLICATIONS

This application claims the benefit of U.S. Provisional Application No. 62/343,142 filed on May 31, 2016, U.S. Provisional Application No. 62/344,998 filed on Jun. 3, 2016. The contents of this application are hereby incorporated by reference in its entirety.

### BACKGROUND OF THE INVENTION

### Field of the invention

The present invention relates to a wireless communication system and more specifically, a method for performing authentication of a user equipment for individual services between the user equipment and a core network; and an apparatus supporting the method.

### Related Art

Mobile communication systems have been developed to provide voice services while assuring users' activities. However, the mobile communication systems have been expanding their areas up to data services as well as voice services, and a current explosive growth of traffic caused a lack of resources, so that users require further advanced mobile communication systems offering quicker services.

As requirements for next-generation mobile communication systems, covering drastically increasing data traffic, a significant increase in transmission rate per user, much more linked devices, very low end-to-end latency, and high energy efficiency should be supported. To this end, various techniques are under research, such as small cell enhancement, dual connectivity, massive MIMO (Multiple Input Multiple Output), in-band full duplex, NOMA (non-orthogonal multiple access), super wideband support, or device networking.

Also, compared with security features evolved up to the specifications in the 4G mobile communication system, the security features expected to be added to the 5G mobile communication system may be described as follows.
The 5G mobile communication system has to accommodate a new type of service delivery model such as network slicing. Network slicing refers to providing a virtual isolated sub-network optimized for service characteristics and aims to provide optimized services for individual applications since requirements differ from application to application.

Accordingly, security architecture also needs to be very flexible according to service characteristics of each network slice, which indicates that the 5G mobile communication network has to be designed to reduce security-related overhead to accommodate network slicing.
The 5G mobile communication system has to be designed not only to provide new functions but also to accommodate new verticals (industries).

This aims to accommodate a new business model about how the mobile communication network and communication should be provided.

In other words, it indicates that a new trust model which takes into account various types of devices (for example, unattended machines, sensors, wearable devices, and vehicles) with security requirements different from each other and some important sectors (for example, public safety and eHealth) has to be defined.
The 5G mobile communication system has to provide optimized Multi-RAT operation. This feature is aimed to reduce OTA signaling and delay required to perform authentication or security setup for Multi-RAT access having a different security mechanism from each other.

In other words, in the existing 4G and previous standards, when connecting to a different RAT, separate authentication and security setting have been performed on a user equipment due to different authentication methods and security setup mechanisms such as key handling even if the user equipment accesses the same core network.

However, the 5G security specification requires that effective Multi-RAT security architecture capable of reducing such redundancy should be provided.

Meanwhile, one of the issues being discussed recently related to the 5G network architecture is to adopt a network slicing concept for the 5G new core network.

In addition, one of the architectural principles of the 5G core network states that a user equipment attaches to a network without setting a session for data transmission, network slices are isolated/separated from each other, and a core network instance (for example, a network slice) is dedicated to terminals of the same type.

The aforementioned statement originates from the fact that the 5G core network is expected to evolve to implement service-oriented architecture, and a fixed, single type of network architecture will not be able to satisfy various service requirements.

In other words, it is not cost-effective to accommodate all the services expected to be provided by the 5G network in a single, fixed network architecture. Therefore, a consensus is formed that network architecture based on a physically fixed structure is divided logically into network slices to accommodate various service requirements.

### SUMMARY OF THE INVENTION

An object of the present invention is to provide a service-specific security setting method to satisfy service-specific requirements for the respective core network slices in the next generation system (for example, 5G system).

Also, an object of the present invention is to provide a method for performing authentication for a service on a network slice basis so that an unauthorized user or user equipment may not access a network slice and waste network resources.

Also, an object of the present invention is to provide a service authentication and security setting method for each network slice based on HSS in case there is an interface between CNIs and HSS.

Technical objects of the present invention are not limited to those introduced above, and other technical objects not described above may be understood clearly by those skilled in the art to which the present invention belongs from the descriptions given below.

A method for performing authentication of a User Equipment (UE) for individual services in a wireless communication system, performed by a first network node providing a common control function, comprises receiving from a RAN (Radio Access Network) node a first message with respect to the UE's request to connect to a core network; and transmitting a second message for requesting authentication of the UE's connection request to a specific second network node on the basis of an indicator included in the first message, wherein the first message includes an indicator indicating that the connection request of the UE requests connection to the specific second network node of the core network.

Also, the method according to the present invention further comprises receiving a response message with respect to the second message from the specific second network node.

Also, the response message according to the present invention includes at least one of a seed key for generating a key used in an access interval between the UE and the RAN node or security attribute information applied to the specific second network node.

Also, the security attribute information according to the present invention is applied to an entity performing a user plane function of the specific second network node.

Also, the method according to the present invention further comprises receiving a third message with respect to a communication service request of the UE from the RAN node; and transmitting the received third message to the specific second network node corresponding to the communication service request.

Also, the method according to the present invention further comprises receiving a response with respect to the communication service request from the specific second network node.

Also, the communication service according to the present invention is provided by the specific second network node.

Also, the second network node according to the present invention is a Core Network Instance (CNI).

Also, an apparatus performing a common control function in a wireless communication system according to the present invention comprises an RF (Radio Frequency) unit transmitting and receiving a radio signal; and a processor functionally connected to the RF unit, wherein the processor is configured to receive a first message with respect to a UE's request to connect to a core network from a RAN (Radio Access Network) node; and to transmit a second message for requesting authentication with respect to the UE's connection request to a specific second network node on the basis of an indicator included in the first message, wherein the first message includes an indicator indicating that the connection request of the UE requests connection to the specific second network node of the core network.

Also, the processor is configured to receive a response message with respect to the second message from the specific second network node.

According to the present invention, a network node providing a common control function (for example, C-CPF) generates security keys for individual CNIs (Core Network Instances) and establishes a security setting between a UE and the respective CNIs so that a security mechanism meeting specific service requirements which vary for each CNI may be applied.

Through the security mechanism, the present invention is capable of applying a different key hierarchy for each CNI providing an actual service, isolating CNIs from each other, and establishing various security settings according to service characteristics.

The advantageous effects that may be obtained from the present invention are not limited to those described above, and other advantageous effects not mentioned above may be clearly understood by those skilled in the art to which the present invention belongs from the descriptions given below.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 illustrates one example of an EPS (Evolved Packet System) related to the LTE system to which technical features of the present invention may be applied.

FIG. 2 illustrates a wireless communication system to which technical features of the present invention may be applied.

FIG. 3 is a block diagram illustrating one example of functional split between an E-UTRAN and an EPC to which technical features of the present invention may be applied.

FIG. 4a is a block diagram illustrating one example of a radio protocol architecture for a user plane to which technical features of the present invention may be applied.

FIG. 4b illustrates one example of a radio protocol architecture for a control plane to which technical features of the present invention may be applied.

FIG. 5a illustrates a security setting method which takes into account the whole network defined in the LTE(-A) system.

FIG. 5b illustrates a security setting method which takes into account the whole network defined in the LTE(-A) system.

FIG. 5c illustrates a security setting method which takes into account the whole network defined in the LTE(-A) system.

FIG. 6 illustrates one example of an initial key activation procedure in the E-UTRAN.

FIG. 7 is a flow diagram illustrating an authentication and key setting procedure at the time of an initial connection to the E-UTRAN.

FIG. 8 illustrates one example of wireless communication system architecture supporting the next-generation RAN to which methods according to the present invention may be applied.

FIG. 9 illustrates another example of wireless communication system architecture supporting the next-generation RAN to which methods according to the present invention may be applied.

FIG. 10 illustrates control plane interfaces for network slicing having common and slice specific functions.

FIG. 11 illustrates a core part implementing the network slicing concept.

FIG. 12 illustrates UEs allocated to a core NSI after Attach phase.

FIG. 13 illustrates one example of a basic concept of network slicing to which a method according to the present invention may be applied.

FIG. 14 illustrates sharing a set of common C-plane functions among a plurality of core network instances to which a method according to the present invention may be applied.

FIG. 15 is a flow diagram illustrating one example of an authentication and selective security setting method for each C-CPF control based service according to the present invention.

FIG. 16 is a flow diagram illustrating another example of an authentication and selective security setting method for each C-CPF control based service according to the present invention.

FIG. 17 is a flow diagram illustrating one example of an authentication and selective security setting method for each HSS-based service according to the present invention.

FIG. 18 is a flow diagram illustrating another example of an authentication and selective security setting method for each HSS-based service according to the present invention.

FIG. 19 is a flow diagram illustrating a yet another example of an authentication and selective security setting method for each HSS-based service according to the present invention.

FIG. 20 is a flow diagram illustrating a still another example of an authentication and selective security setting method for each HSS-based service according to the present invention.

FIG. 21 is a flow diagram illustrating one example of an authentication and selective security setting method for each service according to the present invention.

FIG. 22 is a flow diagram illustrating another example of an authentication and selective security setting method for each service according to the present invention.

FIG. 23 is a block diagram of a wireless communication apparatus to which methods according to the present invention may be applied.

### DESCRIPTION OF EXEMPLARY EMBODIMENTS

Reference will now be made in detail to the preferred embodiments of the present invention, examples of which are illustrated in the accompanying drawings. The detailed description set forth below in connection with the appended drawings is a description of exemplary embodiments and is not intended to represent the only embodiments through which the concepts explained in these embodiments can be practiced. The detailed description includes details for the purpose of providing an understanding of the present invention. However, it will be apparent to those skilled in the art that these teachings may be implemented and practiced without these specific details.

In some instances, known structures and devices are omitted, or are shown in block diagram form focusing on important features of the structures and devices, so as not to obscure the concept of the present invention.

In the embodiments of the present invention, the enhanced Node B (eNode B or eNB) may be a terminal node of a network, which directly communicates with the terminal. In some cases, a specific operation described as performed by the eNB may be performed by an upper node of the eNB. Namely, it is apparent that, in a network comprised of a plurality of network nodes including an eNB, various operations performed for communication with a terminal may be performed by the eNB, or network nodes other than the eNB. The term ‘eNB’ may be replaced with the term ‘fixed station’, ‘base station (BS)’, ‘Node B’, ‘base transceiver system (BTS),’, ‘access point (AP)’, ‘MeNB(Macro eNB or Master eNB)’, ‘SeNB(Secondary eNB)’ etc. The term ‘user equipment (UE)’ may be replaced with the term ‘terminal’, ‘mobile station (MS)’, ‘user terminal (UT)’, ‘mobile subscriber station (MSS)’, ‘subscriber station (SS)’, ‘Advanced Mobile Station (AMS)’, ‘Wireless terminal (WT)’, ‘Machine-Type Communication (MTC) device’, ‘Machine-to-Machine (M2M) device’, Device-to-Device(D2D) device', wireless device, etc.

In the embodiments of the present invention, “downlink (DL)” refers to communication from the eNB to the UE, and “uplink (UL)” refers to communication from the UE to the eNB. In the downlink, transmitter may be a part of eNB, and receiver may be part of UE. In the uplink, transmitter may be a part of UE, and receiver may be part of eNB.

Specific terms used for the embodiments of the present invention are provided to aid in understanding of the present invention. These specific terms may be replaced with other terms within the scope and spirit of the present invention.

The embodiments of the present invention can be supported by standard documents disclosed for at least one of wireless access systems, Institute of Electrical and Electronics Engineers (IEEE) 802, 3rd Generation Partnership Project (3GPP), 3GPP Long Term Evolution (3GPP LTE), LTE-Advanced (LTE-A), and 3GPP2. Steps or parts that are not described to clarify the technical features of the present invention can be supported by those documents. Further, all terms as set forth herein can be explained by the standard documents.

Techniques described herein can be used in various wireless access systems such as Code Division Multiple Access (CDMA), Frequency Division Multiple Access (FDMA), Time Division Multiple Access (TDMA), Orthogonal Frequency Division Multiple Access (OFDMA), Single Carrier-Frequency Division Multiple Access (SC-FDMA), ‘non-orthogonal multiple access (NOMA)’, etc. CDMA may be implemented as a radio technology such as Universal Terrestrial Radio Access (UTRA) or CDMA2000. TDMA may be implemented as a radio technology such as Global System for Mobile communications (GSM)/General Packet Radio Service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, Evolved-UTRA (E-UTRA) etc. UTRA is a part of Universal Mobile Telecommunication System (UMTS). 3GPP LTE is a part of Evolved UMTS (E-UMTS) using E-UTRA. 3GPP LTE employs OFDMA for downlink and SC-FDMA for uplink. LTE-A is an evolution of 3GPP LTE.

Embodiments of the present invention may be supported by standard documents disclosed for at least one of the IEEE 802, 3GPP, and 3GPP2 wireless access systems. In other words, among the embodiments of the present invention, those steps or parts not described for the purpose of clarifying the technical principles of the present invention may be supported by the documents. Also, all of the terms disclosed in the present invention may be described by the standard documents.

To clarify the description of the present invention, the 5G system is mainly dealt with. However, the technical features of the present invention is not limited to the specific system, but may be equally applied to the 3GPP LTE/LTE-A system.

In what follows, before describing the present invention with reference to appended drawings, terms used in the present document are defined briefly for the understanding of the present invention.

APN (Access Point Name): a name of an access point managed by a network, which is provided to a UE. In other words, it indicates the name (character string) of a PDN. On the basis of the name of the access point, the corresponding PDN for transmitting and receiving data is determined.

MME: short for Mobility Management Entity, which is responsible for controlling each entity within an EPS to provide a session and mobility for a UE.

Session: a passage for data transmission. PDN, Bearer, IP flow unit, and so on may be used as a session unit.

As defined in the 3GPP specification, each unit may be distinguished by its application range: a unit for describing the whole network (APN or PDN scale), a unit for describing QoS within the network (Bearer scale), and a destination IP address unit.

TIN: Temporary Identify used in Next update

P-TMSI: Packet Temporary Mobile Subscriber

TAU: Tracking Area Update

GBR: Guaranteed Bit Rate

GTP: GPRS Tunneling Protocol

TEID: Tunnel Endpoint ID

GUTI: Globally Unique Temporary Identity, a UE identifier known to the MME.

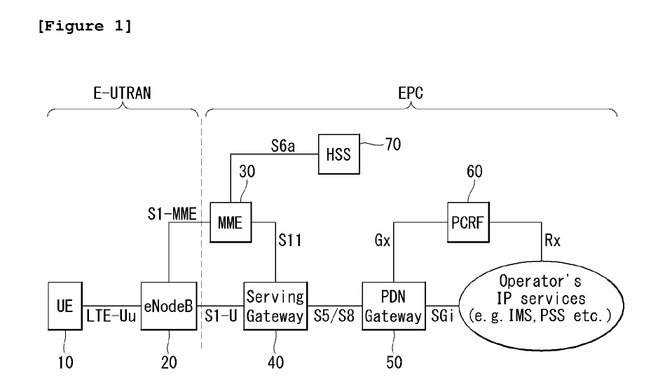

FIG. 1 is a view illustrating an Evolved Packet System which is associated with the Long Term Evolution (LTE) system to which the present invention can be applied. The LTE system aims to provide seamless Internet Protocol (IP) connectivity between a user equipment (UE, 10) and a pack data network (PDN), without any disruption to the end user's application during mobility. While the LTE system encompasses the evolution of the radio access through an E-UTRAN (Evolved Universal Terrestrial Radio Access Network) which defines a radio protocol architecture between a user equipment and a base station(20), it is accompanied by an evolution of the non-radio aspects under the term ‘System Architecture Evolution’ (SAE) which includes an Evolved Packet Core (EPC) network. The LTE and SAE comprise the Evolved Packet System (EPS).

The EPS uses the concept of EPS bearers to route IP traffic from a gateway in the PDN to the UE. A bearer is an IP packet flow with a specific Quality of Service (QoS) between the gateway and the UE. The E-UTRAN and EPC together set up and release the bearers as required by applications.

The EPC, which is also referred to as the core network (CN), controls the UE and manages establishment of the bearers. As depicted in FIG. 1, the node (logical or physical) of the EPC in the SAE includes a Mobility Management Entity (MME) 30, a PDN gateway (PDN-GW or P-GW) 50, a Serving Gateway (S-GW) 40, a Policy and Charging Rules Function (PCRF) 40, a Home subscriber Server (HSS) 70, etc.

The MME 30 is the control node which processes the signaling between the UE and the CN. The protocols running between the UE and the CN are known as the Non-Access Stratum (NAS) protocols. Examples of functions supported by the MME 30 includes functions related to bearer management, which includes the establishment, maintenance and release of the bearers and is handled by the session management layer in the NAS protocol, and functions related to connection management, which includes the establishment of the connection and security between the network and UE, and is handled by the connection or mobility management layer in the NAS protocol layer.

The S-GW 40 serves as the local mobility anchor for the data bearers when the UE moves between eNodeBs. All user IP packets are transferred through the S-GW 40. The S-GW 40 also retains information about the bearers when the UE is in idle state (known as ECM-IDLE) and temporarily buffers downlink data while the MME initiates paging of the UE to re-establish the bearers. Further, it also serves as the mobility anchor for inter-working with other 3GPP technologies such as GPRS (General Packet Radio Service) and UMTS (Universal Mobile Telecommunications System).

The P-GW 50 serves to perform IP address allocation for the UE, as well as QoS enforcement and flow-based charging according to rules from the PCRF 60. The P-GW 50 performs QoS enforcement for Guaranteed Bit Rate (GBR) bearers. It also serves as the mobility anchor for inter-working with non-3GPP technologies such as CDMA2000 and WiMAX networks.

The PCRF 60 serves to perform policy control decision-making, as well as for controlling the flow-based charging functionalities.

The HSS 70, which is also referred to as a Home Location Register (HLR), contains users' SAE subscription data such as the EPS-subscribed QoS profile and any access restrictions for roaming. Further, it also holds information about the PDNs to which the user can connect. This can be in the form of an Access Point Name (APN), which is a label according to DNS (Domain Name system) naming conventions describing the access point to the PDN, or a PDN Address which indicates subscribed IP addresses.

Between the EPS network elements shown in FIG. 1, various interfaces such as an S1-U, S1-MME, S5/S8, S11, S6a, Gx, Rx and SGi are defined.

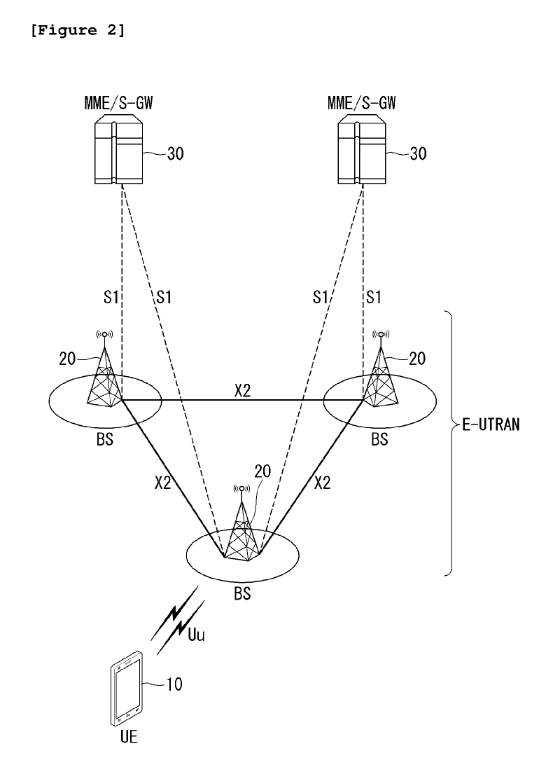

FIG. 2 illustrates a wireless communication system to which the present invention is applied. The wireless communication system may also be referred to as an evolved-UMTS terrestrial radio access network (E-UTRAN) or a long term evolution (LTE)/LTE-A system.

The E-UTRAN includes at least one base station (BS) 20 which provides a control plane and a user plane to a user equipment (UE) 10. The UE 10 may be fixed or mobile, and may be referred to as another terminology, such as a mobile station (MS), a user terminal (UT), a subscriber station (SS), a mobile terminal (MT), a wireless device, etc. The BS 20 is generally a fixed station that communicates with the UE 10 and may be referred to as another terminology, such as an evolved node-B (eNB), a base transceiver system (BTS), an access point, etc.

The BSs 20 are interconnected by means of an X2 interface. The BSs 20 are also connected by means of an S1 interface to an evolved packet core (EPC), more specifically, to a mobility management entity (MME) through S1-MME and to a serving gateway (S-GW) through S1-U.

The EPC includes an MME, an S-GW, and a packet data network-gateway (P-GW). The MME has access information of the UE or capability information of the UE, and such information is generally used for mobility management of the UE. The S-GW is a gateway having an E-UTRAN as an end point. The P-GW is a gateway having a PDN as an end point.

Layers of a radio interface protocol between the UE and the network can be classified into a first layer (L1), a second layer (L2), and a third layer (L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer exchanges an RRC message between the UE and the BS.

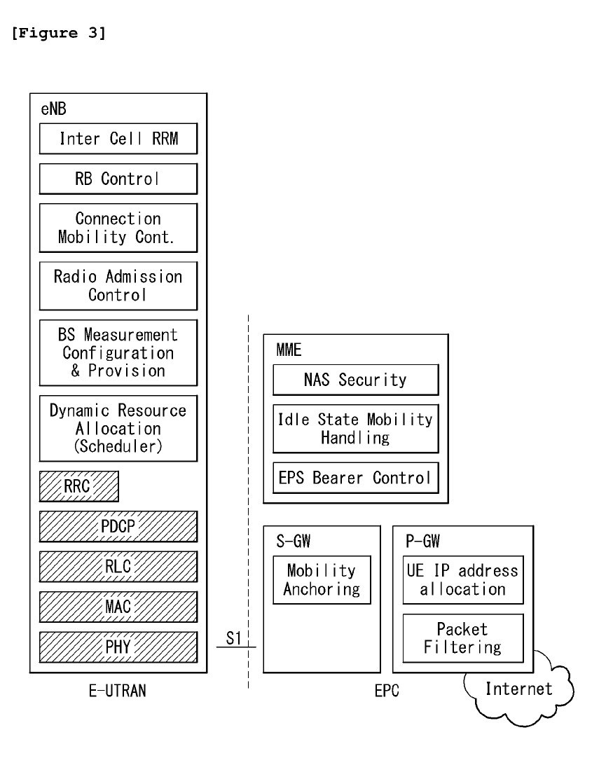

FIG. 3 illustrates a functional split of an E-UTRAN and an EPC to which the present invention can be applied.

Referring to the FIG.3, the eNB may perform functions of selection for the gateway (for example, MME), routing toward the gateway during a radio resource control (RRC) activation, scheduling and transmitting of paging messages, scheduling and transmitting of broadcast channel (BCH) information, dynamic allocation of resources to the UEs in both uplink and downlink, configuration and provisioning of eNB measurements, radio bearer control, radio admission control (RAC), and connection mobility control in LTE_ACTIVE state. In the EPC, and as mentioned above, the gateway may perform functions of paging origination, LTE_IDLE state management, ciphering of the user plane, System Architecture Evolution (SAE) bearer control, and ciphering and integrity protection of NAS signaling.

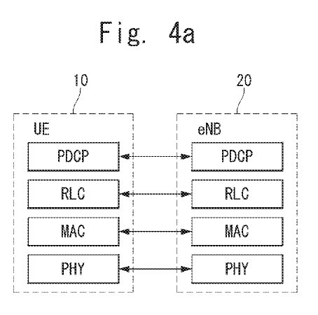

FIG. 4A is a diagram illustrating a radio protocol architecture for a user plane. FIG. 4B is a diagram illustrating a radio protocol architecture for a control plane. The user plane is a protocol stack for user data transmission. The control plane is a protocol stack for control signal transmission.

Referring to FIGS. 4A and 4B, a PHY layer provides an upper layer with an information transfer service through a physical channel. The PHY layer is connected to a medium access control (MAC) layer which is an upper layer of the PHY layer through a transport channel. Data is transferred between the MAC layer and the PHY layer through the transport channel. The transport channel is classified according to how and with what characteristics data is transmitted through a radio interface.

Between different PHY layers, i.e., a PHY layer of a transmitter and a PHY layer of a receiver, data are transferred through the physical channel. The physical channel is modulated using an orthogonal frequency division multiplexing (OFDM) scheme, and utilizes time and frequency as a radio resource.

A function of the MAC layer includes mapping between a logical channel and a transport channel and multiplexing/de-multiplexing on a transport block provided to a physical channel over a transport channel of a MAC service data unit (SDU) belonging to the logical channel. The MAC layer provides a service to a radio link control (RLC) layer through the logical channel.

A function of the RLC layer includes RLC SDU concatenation, segmentation, and reassembly. To ensure a variety of quality of service (QoS) required by a radio bearer (RB), the RLC layer provides three operation modes, i.e., a transparent mode (TM), an unacknowledged mode (UM), and an acknowledged mode (AM). The AM RLC provides error correction by using an automatic repeat request (ARQ).

Functions of a packet data convergence protocol (PDCP) layer in the user plane include user data delivery, header compression, and ciphering. Functions of a PDCP layer in the control plane include control-plane data delivery and ciphering/integrity protection.

A radio resource control (RRC) layer is defined only in the control plane. The RRC layer serves to control the logical channel, the transport channel, and the physical channel in association with configuration, reconfiguration and release of radio bearers (RBs). An RB is a logical path provided by the first layer (i.e., PHY layer) and the second layer (i.e., MAC layer, RLC layer, and PDCP layer) for data delivery between the UE and the network.

The configuration of the RB implies a process for specifying a radio protocol layer and channel properties to provide a specific service and for determining respective detailed parameters and operations. The RB can be classified into two types, i.e., a signaling RB (SRB) and a data RB (DRB). The SRB is used as a path for transmitting an RRC message in the control plane. The DRB is used as a path for transmitting user data in the user plane.

When an RRC connection exists between an RRC layer of the UE and an RRC layer of the network, the UE is in an RRC connected state, and otherwise the UE is in an RRC idle state.

Data are transmitted from the network to the UE through a downlink transport channel. Examples of the downlink transport channel include a broadcast channel (BCH) for transmitting system information and a downlink-shared channel (SCH) for transmitting user traffic or control messages. The user traffic of downlink multicast or broadcast services or the control messages can be transmitted on the downlink-SCH or an additional downlink multicast channel (MCH). Data are transmitted from the UE to the network through an uplink transport channel. Examples of the uplink transport channel include a random access channel (RACH) for transmitting an initial control message and an uplink SCH for transmitting user traffic or control messages.

Examples of logical channels belonging to a higher channel of the transport channel and mapped onto the transport channels include a broadcast channel (BCCH), a paging control channel (PCCH), a common control channel (CCCH), a multicast control channel (MCCH), a multicast traffic channel (MTCH), etc.

The physical channel includes several symbols in a time domain and several sub-carriers in a frequency domain. One sub-frame includes a plurality of symbols in the time domain. One subframe includes a plurality of resource blocks. One resource block includes a plurality of symbols and a plurality of sub-carriers. Further, each subframe may use specific sub-carriers of specific symbols (e.g., a first symbol) of a corresponding subframe for a physical downlink control channel (PDCCH), i.e., an L1/L2 control channel. A transmission time interval (TTI) is a unit time of data transmission, and is 1 millisecond (ms) which corresponds to one subframe.

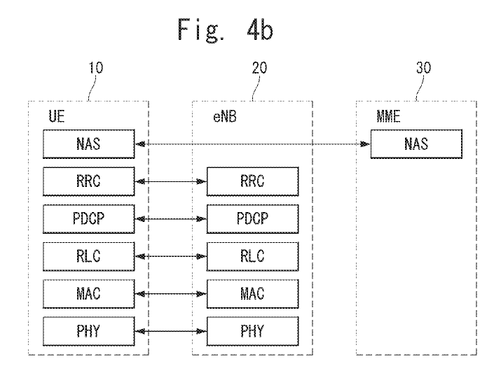

With reference to FIGS. 5a, 5b and 5c, the current LTE/LTE-A system performs authentication simultaneously with connection to an MME of a core network regardless of the service provided to the UE, and as a result of the authentication, sets up a NAS/AS key, and performs communication to receive a service.

FIG. 5a, FIG. 5b and FIG. 5c illustrate a security setting method which takes into account the whole network defined in the LTE(-A) system.

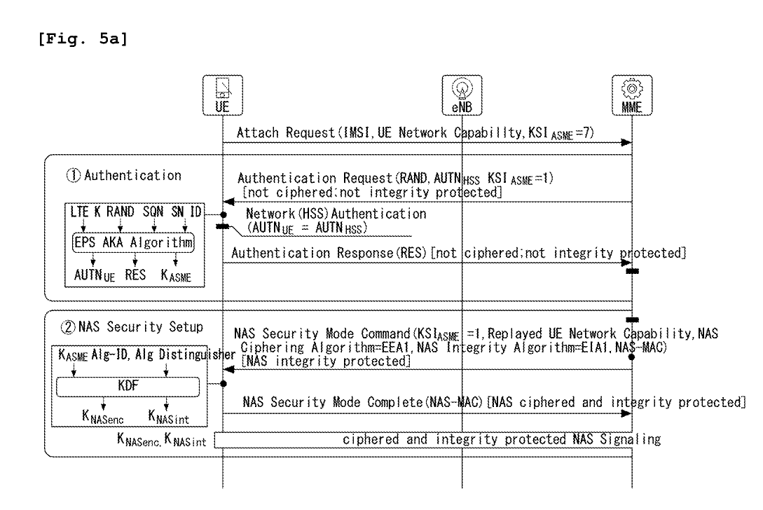

FIG. 5a, FIG. 5b and FIG. 5c show one connected procedure, and FIG. 5c shows a procedure performed after FIG. 5a and FIG. 5b. FIG. 6 illustrates one example of an initial key activation procedure in the E-UTRAN.

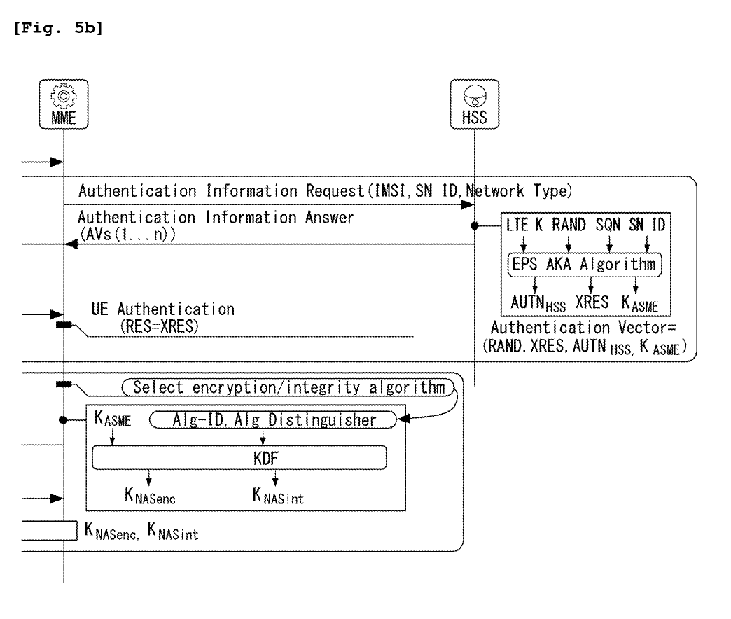

FIG. 7 is a flow diagram illustrating an authentication and key setting procedure at the time of an initial connection to the E-UTRAN.

In other words, FIG. 6 illustrates an overall procedure through which authentication and key setting for a UE is performed when the user performs an initial connection in the 4G system (LTE(-A) system).

With reference to FIG. 6, after performing a random access, the UE establishes an RRC connection to an eNB through a first to third procedures (RRC Connection Setup Request, RRC Connection Setup, and RRC Connection Setup Complete).

Afterwards, through the Attach procedure to the MME, the UE performs authentication and key setting for data/control signaling protection of the AS/NAS layer.

FIG. 7 elaborates the authentication procedure performed in the network access procedure of FIG. 6.

FIG. 7 shows only the parts necessary for the UE to perform the initial access, but excludes those parts which may be performed selectively depending on situations.

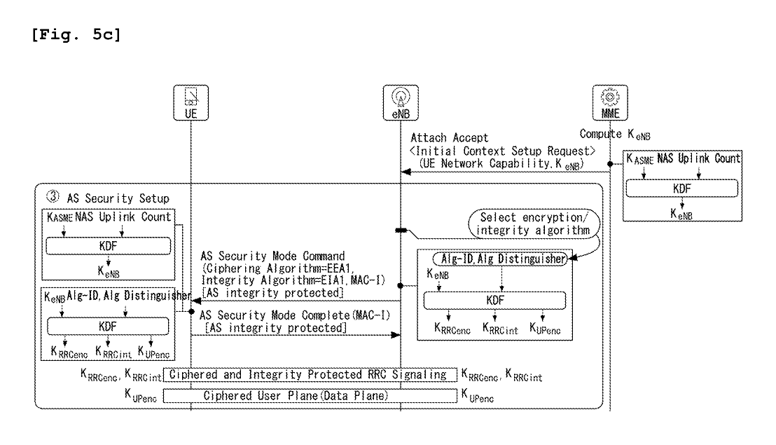

Next, with reference to FIGS. 8 to 12, described will be embodiments of wireless communication system architecture for supporting the next-generation RAN to which methods according to the present invention may be applied.

FIG. 8 illustrates one example of wireless communication system architecture supporting the next-generation RAN to which methods according to the present invention may be applied.

The wireless communication system architecture supporting the next-generation RAN may be termed as ‘high level architecture’.

The term of Next Generation may be expressed briefly as ‘Next Gen’, where the future generations of communication including the 5G system may be called collectively the next generation.

In the following, for the convenience of description, the next generation will be referred to as “Next Gen”.

The “Next Gen” architecture to which methods according to the present invention may be applied supports new RAT(s), evolved LTE, and non-3GPP access types, but does not support GERAN and UTRAN.

Examples of the non-3GPP access type include WLAN access and fixed access.

Also, the “Next Gen” architecture supports a unified authentication framework for other access systems and supports simultaneous connection to a plurality of UEs through a plurality of access technologies.

Also, the “Next Gen” architecture allows independent evolution of the core network and RAN and minimizes access dependency.

Also, the “Next Gen” architecture supports separation of control and user plane functions and supports transmission of IP packets, non-IP PDUs, and Ethernet frames.

With reference to FIG. 8, the “Next Gen” architecture may include the NextGen UE 810, NextGen RAN 820, NextGen Core 830, and Data Network 840.

At this time, in the “Next Gen” wireless communication system, a UE may be expressed as ‘NextGen UE’, RAN which defines radio protocol architecture between the UE and the eNB may be expressed as ‘NextGen RAN’, and core network which performs management of IP packet flow may be expressed as ‘NextGen Core’.

As one example, ‘NextGen RAN’ may correspond to the E-UTRAN of the LTE(-A) system, ‘NextGen Core’ may correspond to the EPC of the LTE(-A) system, and the network entities performing the same function as the MME, S-GW, and P-GW of the LTE EPC may also be included in the NextGen Core.

NG1-C and NG1-U interfaces are defined between the NextGen RAN and the NextGen Core, and NG-Gi interface is defined between the NextGen Core and the Data Network.

At this time, the NG1-C represents a reference point for the control plane between the NextGen RAN and the NextGen Core, and the NG1-U represents a reference point for the user plane between the NextGen RAN and the NextGen Core.

Although not shown in FIG. 8, the NG-NAS represents a reference point for the control plane between the NextGen UE and the NextGen Core.

Also, the NG-Gi represents a reference point between the NextGen Core and the Data Network.

At this time, the Data Network may correspond to an operator external public network, private data network, or intra-operator data network.

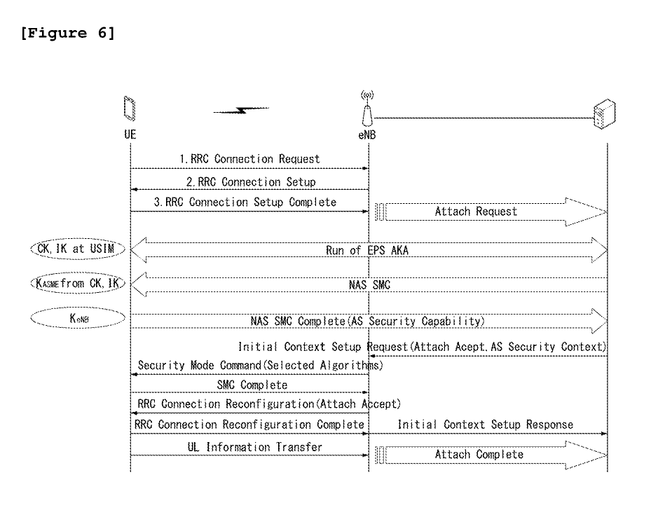

FIG. 9 illustrates another example of wireless communication system architecture supporting the next-generation RAN to which methods according to the present invention may be applied.

In particular, FIG. 9 illustrates the NextGen core of FIG. 8 in detail by dividing it into the control plane (CP) and user plane (UP) functions; and illustrates the interfaces between the UE, AN, and AF in more detail.

In what follows, a flow-based QoS handling method will be described in more detail with reference to FIG. 9.

With reference to FIG. 9, in the wireless communication system to which the present invention is applied, QoS (Quality of Service) policy may be stored and configured by the CP (Control Plane) function 531 according to the following needs:
Application in the UP (User Plane) function 532 and
Transmission from the AN (Admission Control) 520 and the UE 510 for QoS application

As shown in FIG. 9, the CP and the UP functions are included in the NextGen CN (indicated by a dotted line) and may be implemented by one physical device or by different physical devices separately.

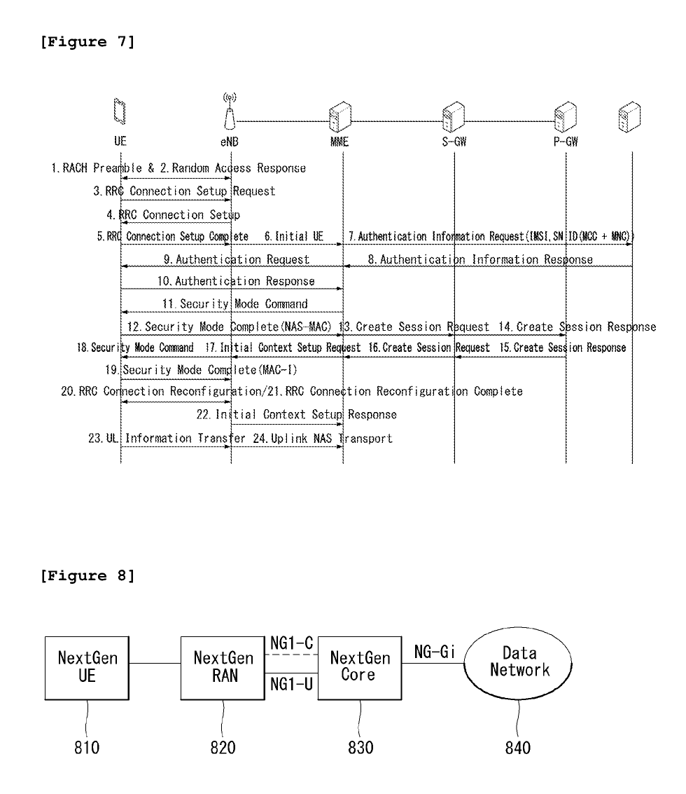

FIGS. 10 to 12 illustrate other examples of wireless communication system architecture supporting the next-generation RAN to which methods according to the present invention may be applied.

In other words, FIGS. 10 to 12 illustrate examples of wireless communication system architecture for supporting the next-generation RAN including the network slicing concept described throughout the present document.

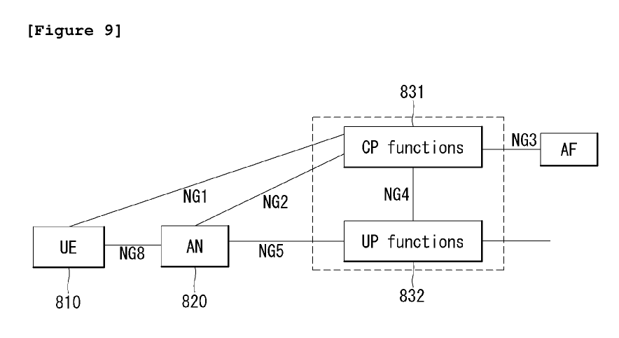

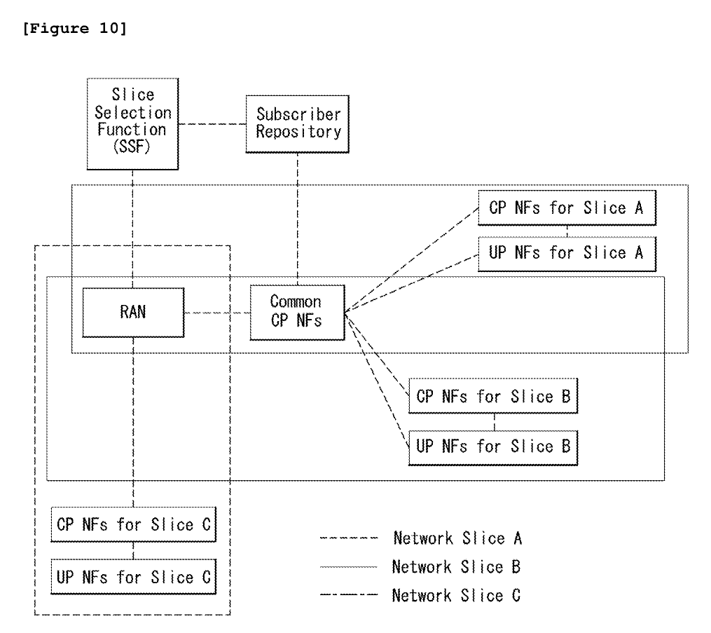

More specifically, FIG. 10 illustrates control plane interfaces for network slicing having common and slice specific functions, FIG. 11 illustrates a core part implementing the network slicing concept, and FIG. 12 illustrates UEs allocated to a core NSI after Attach phase.

With reference to FIG. 11, the control plane of the NextGen Core (or 5G Network Core) is divided into two types of Network Functions (NFs).

The two types of NFs may correspond to CCNF (Common Control Plane Network Function) and SCNF (Slice-specific Control Plane Network Function).

The CCNF may be expressed by C-CPF.

The CCNF is a set of basic control plane network functions for supporting operation of basic functions which are commonly used among NSIs within the NextGen Core.

Also, Core Network Slice may be expressed by Core Network Instance.

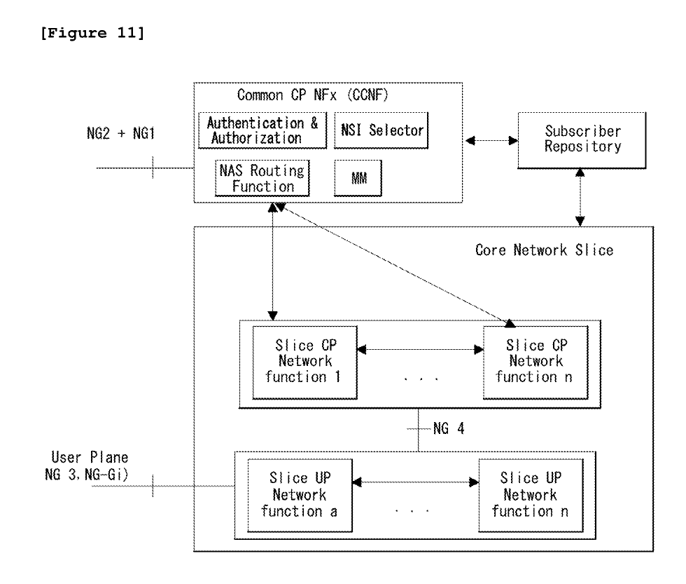

FIG. 13 illustrates one example of a basic concept of network slicing to which a method according to the present invention may be applied.

FIG. 13 assumes that a specific network slice of a specific PLMN is not visible to any UE connected through a radio interface.

Therefore, a function for slice routing and selection is necessary.

The aforementioned function performs the role of connecting an RB (Radio Bearer) of the UE to an appropriate core network instance.

To summarize, RAN appears only as RAT +PLMN to the UE; which network slice (network instance) the UE is associated with is performed within the network and the UE is not involved therein.

Meanwhile, RAN may provide slice selection and routing function, which is similar to NNSF (Network Node Selection Function), one of functions performed by eNBs of the current 4G system.

Slice selection and routing function may also be provided by the Core Network.

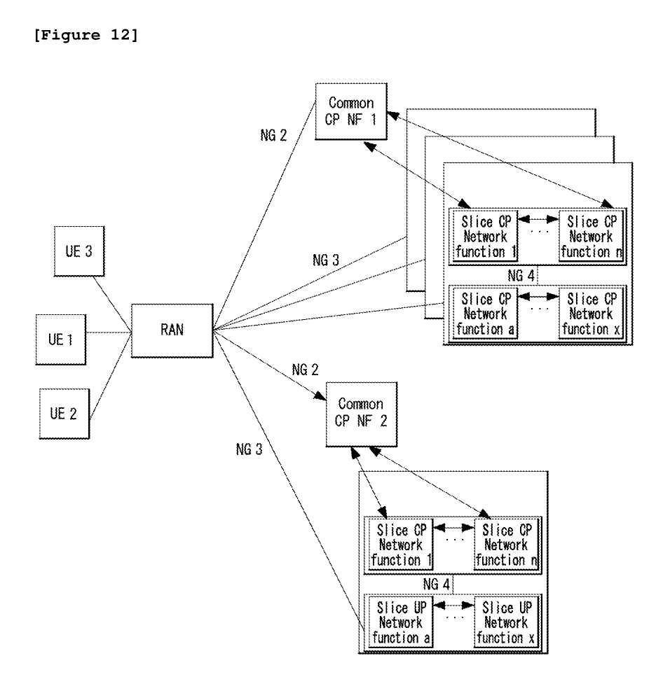

FIG. 14 illustrates sharing a set of common C-plane functions among a plurality of core network instances to which a method according to the present invention may be applied.

As described above, the 5G network architecture is expected to accommodate the concept of network slicing in the core network.

FIG. 14 illustrates one example of such architecture, and according to the architecture shown in FIG. 14, a UE is connected to CNIs for actual services through common CPFs.

In other words, accommodating the concept of network slicing in the 5G core network indicates that a security mechanism relevant to a CNI, which is a logical network optimized for providing a service with the corresponding service requirements, has to be provided.

One method to accommodate the network slicing is to provide a different security configuration for each CNI for a UE which has been authenticated through C-CPF by consulting the UE for the security configuration satisfying service characteristics or requirements that a network slice provides and setting the UE with the security configuration by using the seed key generated and delivered by the C-CPF for each network slide.

According to the method above, authentication of a UE to connect to the 5G core network may be performed before or after NSSF/CPSF selects a specific CNI.

Also, isolation among slices may be ensured by setting a different security key for each CNI by using a CNI seed key generated from authentication of a UE and letting the generated security key used for communication of a radio interval for a service.

Also, a security procedure for accessing network slices is also needed, by which a UE may access a network slice exactly.

In case a UE is not authenticated or authorized for using a specific network slice, an unauthorized UE may be connected to the network slice to waste resources.

Therefore, to ensure a network slice to be allocated to an authorized subscriber or UE and to prevent an unauthorized user from being connected to a network slice and wasting network resources, it may be necessary to perform authentication of a service for each network slice.

Since the 5G system is aimed at a service-oriented network, fixed-type authentication and security configuration which does not take into account service requirements as in the 4G system becomes an obstacle to provide various services to be realized in the 5G system.

Therefore, the 5G system needs to construct network slices so that service-specific security requirements may be satisfied rather than applying the same security mechanism across the whole network as in the existing systems and to provide different security mechanisms for individual network slices.

Therefore, the present invention provides a service authentication and selective security configuration method for individual CNIs (Core Network Instances) for a UE to receive a service from the CNIs for each network segment or network slice through a 5G core network which supports a concept of network slicing to provide new 5G (or next-generation) services efficiently.

In other words, in case the concept of network slicing is accommodated by the 5G core network to provide new 5G services efficiently, CNIs required to provide individual services have to provide a security mechanism satisfying requirements of the corresponding service and to ensure an unauthenticated/unauthorized UE or subscriber not to waste network resources by connecting to a network slice.

In other words, in case the 5G core network evolves to provide applications requiring not only low latency transmission less than 1 ms but also high reliability (where packet error rate is required to be less than 1e-9) demanded by remote control services in the medical, industrial, and robotics applications; and services related to smart car safety, a UE may receive a plurality of services through a plurality of CNIs (network slices).

Therefore, the present invention provides a method for performing authentication of a service for each CNI to provide an actual service only to those UEs authenticated through a C-CPF (Common Control Plane Function) during a network connection process and performing security configuration satisfying the respective service requirements from the authentication result.

In what follows, described in more detail through various embodiments will be a method for performing service authentication for each CNI to provide an actual service only to those UEs which have completed authentication through a C-CPF during a network connection process and methods for providing security configuration satisfying the respective service requirements from the authentication result according to the present invention.

### First Embodiment

In the first embodiment, while performing a connection request of a UE, a common control plane function (C-CPF) controlling network access of the UE obtains a sub-master key to be used for service authentication by individual CNIs as a result of an authentication procedure for network access from an HSS and delivers the sub-master key to the CNIs. The CPFs corresponding to the respective CNIs perform authentication for CNI connection (session configuration) by using the sub-master key received during a session configuration process in conjunction with the UE and generate a security key of the corresponding access interval.

At this time, the sub-master key may be expressed as a first security key in a general sense and in what follows, is expressed in the original term for the convenience of description.

Also, the sub-master key generated by the HSS is managed by the CPF, and the CPFs corresponding to a CNI request the sub-master key from the C-CPF during a session configuration process in conjunction with the UE. The CPFs then perform authentication for CNI connection (session configuration) by using the requested sub-master key and generates a key of the corresponding access interval.

Also, in this process, a CNI and a UE may adjust various security attributes according to service characteristics provided by the corresponding CNI.

As described above, the first embodiment may prevent an unauthorized user or UE from being connected to a network slice to waste network resources by performing authentication of a service for each network slice (CNI) having different service requirements.

Also, since the first embodiment provides a method by which a security mechanism relevant to the corresponding service requirements may be applied, a different security key hierarchy may be configured for each CNI which provides an actual service, and CNIs may be isolated from each other. Thus, eventually various security configurations may be applied according to service characteristics.

To describe the first embodiment in more detail, in case a connection request is received from a UE, the common control plane function (C-CPF) which controls network access of the corresponding UE obtains from the HSS a sub-master key to be used for service authentication by individual CNIs as a result of performing the authentication procedure for network access (the key generated by applying a one-way hash function with respect to Ki in the case of the 4G system and the key generated by applying a one-way hash function with respect to the master key corresponding to Ki in the case of the 5G system).

Afterwards, the C-CPF delivers a sub-master key obtained from the HSS to the CNIs.

Next, CPFs corresponding to the respective CNIs perform authentication for CNI connection (session configuration) by using the sub-master key received during a session configuration process in conjunction with the UE and generate a key for the access interval.

Similarly, the sub-master key generated by the HSS is maintained by the CPF; and the CPFs corresponding to the respective CNIs request a sub-master key from the C-CPF during the session configuration process in conjunction with the UE, perform authentication for CNI connection (session configuration) by using the sub-master key, and generate a key for the access interval.

At the same time, each CNI and the UE may adjust (or exchange) various security attributes with the UE according to the service characteristics provided by the corresponding CNI.

For example, the security attribute may include the size of a security key used for encoding and decoding, an indicator about whether to apply an encoding or integrity algorithm according to service characteristics, and so on.

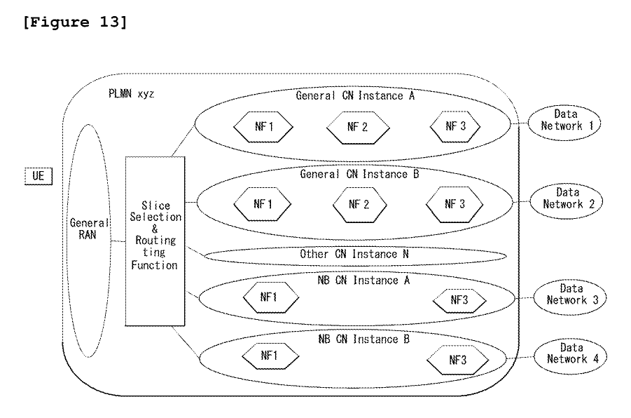

FIG. 15 is a flow diagram illustrating one example of an authentication and selective security setting method for each C-CPF control based service according to the present invention.

With reference to FIG. 15, a wireless communication system to which a method according to the present invention may be applied includes a UE, RAN node, NSSF/CPSF, C-CPF, HSS, and one or more CNIs (CPFs, UPFs).

As shown in FIG. 14, FIG. 15 assumes that a plurality of CNIs share a common (or one) C-CPFs.

In this case, selection of a network segment (or slice) may be performed through an application ID (IDentity) and service descriptor (for example, eMBB, CriC, and mMTC) provided by a UE or may be performed through subscriber information of the UE managed by the network (for example, HSS of the LTE system).

FIG. 15 illustrates one example of service authentication and selective security configuration procedure for each network slice operating in the 5G new core network which accommodates the concept of network slicing shown in FIG. 14.

Also, FIG. 15 assumes that an interface is defined only between the HSS which stores subscriber information of the UE (or a 5G new core network entity corresponding to the HSS) and the C-CPF (Common CPF).

In other words, the CNIs of FIG. 15 are not connected to the HSS, and the CNIs have to pass the C-CPF to obtain the information maintained by the HSS.

With reference to FIG. 15, the UE transmits a network connection request message to establish a connection to the operator network (CNI(s)).

The network connection request message is delivered to the NNSF (Network Slice Selection Function)/CPSF (C-Plane Selection Function) through a RAN node S1501.

If the UE provides information about a specific CNI and CPF (Control Plane Function) of the CNI to the RAN node, the network connection request message may be delivered directly to the CPF of the specific CNI from the UE.

Afterwards, the NNSF/CPSF determines the CNI to which the UE is to be connected and CPF of the corresponding CNI according to the information included in the network connection request message that the UE has requested S1502.

In the case of FIG. 15, it may be seen that the CNI included in the network connection request message by the UE is CPF #1.

Afterwards, the NNSF/CPSF delivers information about the CPF (CPF #1) of the CNI to the RAN node S1503.

Afterwards, the RAN node selects the CPF of the CNI according to the response from the NNSF/CPSF S1504.

Although one example of the RAN node may be an eNB, but the present invention is not limited to the aforementioned example.

The RAN node delivers the network connection request message of the UE to the C-CPF (C-CPF-1 in FIG. 15) S1505, which is a request of the UE for connecting to the CNI #1.

In other words, the aforementioned request is intended to be authorized to use a common control function provided by the network.

The C-CPF performs authentication for connecting the UE to the CNI-1 S1506.

Afterwards, the C-CPF obtains a sub-master key which is to be used for each CNI as a result of the authentication of the UE S1507.

At this time, the sub-master key may be regarded as a key generated by applying a one-way hash function with respect to Ki of the 4G system (for example, KDF (Ki, network slice—ID) or a key generated by applying a one-way hash function with respect to a unique master key corresponding to Ki (for example, KDF (master key, network slice—ID unique to the 5G system corresponding to Ki)) in the case of the 5G system.

The sub-master key to be used for each CNI may be generated by the HSS, which may be obtained through the procedure in the S1506 step for the C-CPF's requesting and receiving an authentication vector for authentication of the UE from the HSS.

In other words, the master key of the UE is remained in the HSS as it is, and if authentication of the UE is completed as the C-CPF receives a sub-master key for each CNI from the HSS, the C-CPF delivers the received sub-master key to each CNI.

Then, the C-CPF delivers the sub-master key generated for each CNI to the corresponding CPF of the CNI S1508.

In other words, the C-CPF may generate a sub-master key for each CNI (CNI #1, CNI #2) of the corresponding UE according to subscriber information of the UE and deliver the generated sub-master key to the CPFs of the corresponding CNI.

Afterwards, the UE delivers a request for a communication service (which indicates a service #1 provided by the CNI #1) to the RAN node S1509.

At this point, the UE is informed of the CNI of the service requested by itself and may generate a CNI-specific sub-master key by using the ID of the corresponding CNI according to the method described in the S1507 step.

The request for a communication service to the CNI-1 may include security capability information of the corresponding UE.

The security capability information of the UE is included to modify the algorithm for encryption/integrity between the UE and the CNI-1 or to adjust a supported key size.

Afterwards, the RAN node delivers a communication service request of the UE to the C-CPF, and the C-CPF delivers the communication service request to the CPF corresponding to the CNI-1 (for example, CPF of the CNI-1) S1510.

Afterwards, the UE and the CPF of the CNI-1 perform an authentication procedure for connection to the CNI-1 S1511.

Through the process above, the UE and the CNI-1 may respectively generate a seed key (KeNB in the case of the 4G system and a key corresponding to the KeNB in the case of the 5G system) for generating a key to the access interval to be used by the UE and the RAN node.

Afterwards, after authentication of the UE and session configuration are completed successfully, the CPF of the CNI-1 delivers a session response to the C-CPF, and the C-CPF delivers the session response to the RAN node S1512.

The session response may include a seed key for generating a key to be used in the access interval generated by the CPF of the CNI-1 between the UE and the RAN node; and information about security attributes that may be applied to CNI-1 UPF-1.

The seed key is delivered to the RAN node to generate a key to be used in the access interval through interactions (for example, AS security command in the case of the 4G system and a procedure corresponding to AS security command of the 4G system in the case of the 5G system) between the RAN node which has received the seed key and the UE.

Meanwhile, information related to security attributes according to service characteristics is included to inform the UE of the security setting which may be applied according to the characteristics of the service provided by the CNI-1.

Information about encryption/integrity algorithm aimed to be applied for providing a service according to the security capability received by the CNI-1 from the UE or key size may also be included in the security attributes.

Afterwards, the RAN node delivers the received session response to the UE S1513.

At this time, the RAN node exclude the seed key received from the CNI-CPF via the C-CPF and sends only the remaining information (for example, security attributes according to service characteristics).

If the UE and a specific CNI CPF successfully authenticate each other by using a sub-master key through the session request/session response, the corresponding UE and the CNI-CPF may generate a seed key for generating keys to be actually used for a service in the access interval.

The generated seed key is delivered to the RAN node by the CNI-CPF, and the corresponding RAN node and the UE may generate a key for the access interval respectively from the seed key.

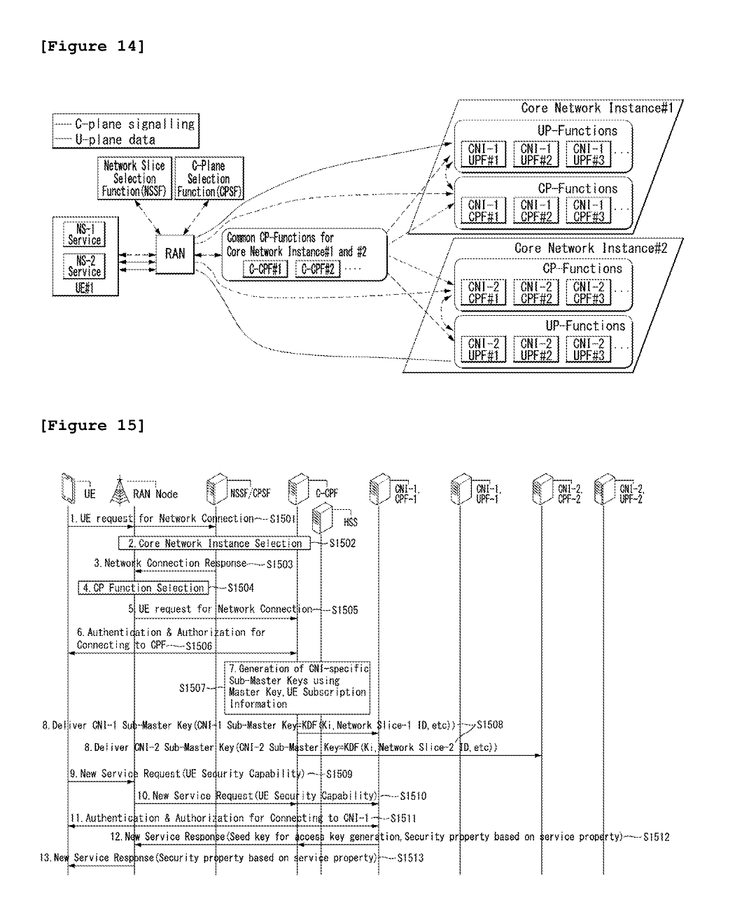

FIG. 16 is a flow diagram illustrating another example of an authentication and selective security setting method for each C-CPF control based service according to the present invention.

In other words, FIG. 16 illustrates another example of a service-specific security setting procedure of the present invention according to the 5G new core network architecture which accommodates the concept of network slicing of FIG. 14.

In the case of FIG. 16, it is assumed that an interface is defined only between the HSS which stores subscriber information of the UE (or an entity of the 5G new core network corresponding to the HSS) and the C-CPF (Common CPF) in the same way as FIG. 15.

In other words, CNIs are not connected to the HSS and have to pass the C-CPF to obtain the information maintained by the HSS.

Since the S1601 to S1607 steps of FIG. 16 are the same as the S1501 to S1507 steps of FIG. 15, FIG. 15 may be consulted for detailed descriptions; hereinafter, only those parts of FIG. 16 exhibiting a difference from those of FIG. 15 will be described.

With reference to FIG. 16, after the S1607, the UE delivers a request for a communication service (which indicates service #1 provided by CNI #1) to the RAN node S1608.

At this point, the UE is informed of the CNI of the service that the UE itself has requested and may generate a CNI-specific sub-master key by using the same method described in the S1607 step by using the ID of the corresponding CNI.

The request for a communication service from the CNI-1 may include security capability information of the corresponding UE.

The security capability information of the UE is included to modify an encryption/integrity algorithm between the UE and the CNI-1 or adjust information such as the supported key size.

Afterwards, the RAN node delivers a communication service request of the UE to the C-CPF, and the C-CPF delivers the communication service request to the CPF corresponding to CNI-1 (for example, CPF of CNI-1) S1609.

Afterwards, the CPF corresponding to the CNI-1 delivers a key request including the information about the identifier of the UE which has requested the CPF itself to establish a session to the C-CPF S1610.

The above operation is intended to obtain a sub-master key for each CNI generated by the C-CPF.

Afterwards, in response to the request of the CNI-1 CPF, the C-CPF delivers a key response including the sub-master key generated for the CNI with respect to the corresponding UE S1611.

Afterwards, the UE and the CPF of the CNI-1 perform an authentication procedure for connection to the CNI-1 S1612.

Through the process described above, the UE and the CNI-1 may respectively generate a seed key (KeNB in the case of the 4G system and a key corresponding to the KeNB in the case of the 5G system) for generating a key for the access interval to be used by the UE and the RAN node.

Afterwards, after authentication of the UE and session configuration are completed successfully, the CPF of the CNI-1 delivers a session response to the C-CPF, and the C-CPF delivers the session response to the RAN node S1613.

The session response may include a seed key for generating a key to be used in the access interval generated by the CPF of the CNI-1 between the UE and the RAN node; and information about security attributes that may be applied to CNI-1 UPF-1.

The seed key is delivered to the RAN node to generate a key to be used in the access interval through interactions (for example, AS security command in the case of the 4G system and a procedure corresponding to AS security command of the 4G system in the case of the 5G system) between the RAN node which has received the seed key and the UE.

Meanwhile, information related to security attributes according to service characteristics is included to inform the UE of the security setting which may be applied according to the characteristics of the service provided by the CNI-1.

Information about encryption/integrity algorithm aimed to be applied for providing a service according to the security capability received by the CNI-1 from the UE or key size may also be included in the security attributes.

Afterwards, the RAN node delivers the received session response to the UE S1614.

At this time, the RAN node exclude the seed key received from the CNI-CPF via the C-CPF and sends only the remaining information (for example, security attributes according to service characteristics).

In what follows, described through a second and a third embodiment according to the present invention will be a method for CNIs to perform authentication and selective security setting in conjunction with an HSS for a UE and a service.

In other words, assuming that an interface is defined between CNIs and the HSS, the second and the third embodiment provide a method for CNIs to perform authentication for a UE and a service with the help of the HSS.

In the second embodiment, while performing a connection request of a UE, a C-CPF controlling network access of the corresponding UE requests the corresponding CNI to perform an authentication procedure on the UE to establish a network access for connecting to a specific CNI, and the CPF of the CNI which has received the request performs authentication of the corresponding UE in conjunction with the (local) HSS.

At this time, it is assumed that the (local) HSS stores a service-specific master key to be used for service authentication with respect to the corresponding UE, and the UE has the same master key.

The service-specific master key may be a key derived from Ki in the case of the existing 4G system while it may be a key derived from a master key corresponding to Ki of the 4G system in the case of the 5G system.

In other words, the UE has a service-specific master key for each CNI and performs service authentication in conjunction with each CNI by using the master key.

Afterwards, the CNI-CPF delivers an authentication result for the UE to the C-CPF.

The authentication result includes information about a seed key for generating a key for the access interval between the UE and the RAN node (for example, eNB) and information related to security attributes according to the characteristics of a service provided by the CNI.

The C-CPF receives the information and delivers the received information to the RAN node through an acceptance message for connection to the CNI. And the RAN node receives the information and generated a key for the access interval in conjunction with the UE.

Also, in the case of the third embodiment, while performing a connection request of the UE, the C-CPF makes the HSS generate a CNI-specific (sub-master) key (a key generated by applying a one-way hash function with respect to Ki in the case of the 4G system and a key generated by applying a one-way hash function with respect to a master key corresponding to Ki in the case of the 5G system) to be used for service authentication by individual CNIs from the result of the authentication procedure for network access.

Afterwards, the C-CPF allows the HSS to deliver the generated CNI-specific (sub-master) key to each CNI.

Afterwards, CPFs of the CNI perform authentication for CNI connection (session configuration) by using the CNI-specific key received from the HSS during the session configuration process in conjunction with the UE and generates a key for the access interval.

Similarly, while the HSS maintains/manages a CNI-specific key that the HSS itself has generated, CPFs of the CNI request a CNI-specific key from the HSS during the session configuration process in conjunction with the UE, performs authentication for CNI connection (session configuration) by using the CNI-specific key, and generates a key for the access interval.

During the process above, the CNI may adjust various security attributes in conjunction with the UE according to service characteristics provided by the corresponding CNI.

Specific examples of the security attribute may include size of a security key used for encryption/decryption and information about whether an encryption/integrity algorithm according to service characteristics is applied.

The first embodiment aims to solve inefficiency due to failing to meet various service requirements by performing security setting regardless of service characteristics as in the security configuration for the existing 4G system.

### Second Embodiment

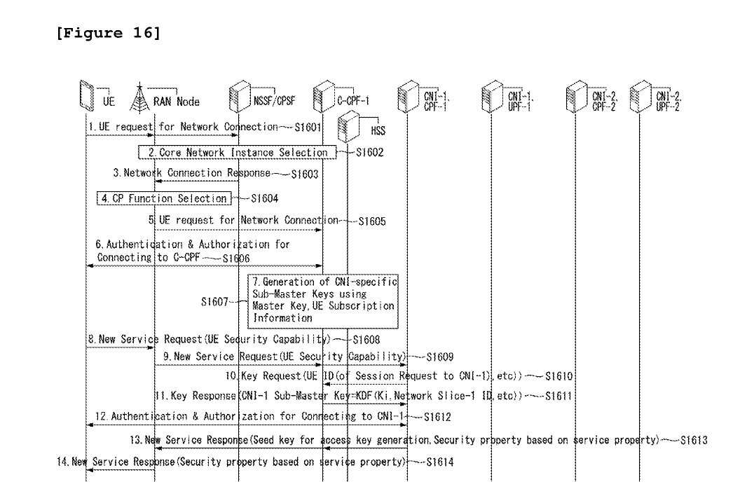

FIG. 17 is a flow diagram illustrating one example of an authentication and selective security setting method for each HSS-based service according to the present invention.

With reference to FIG. 17, a wireless communication system to which a method according to the present invention is applied may include a UE, RAN node, NSSF/CPSF, C-CPF, HSS, (Local) HSS, and one or more CNIs (CPF, UPF).

As shown in FIG. 14, FIG. 17 assumes that a plurality of CNIs share a common (or one) C-CPFs.

In this case, selection of a network segment (or slice) may be performed through an application ID (IDentity) and service descriptor (for example, eMBB, CriC, and mMTC) provided by a UE or may be performed through subscriber information of the UE managed by the network (for example, HSS of the LTE system).

FIG. 17 illustrates one example of service authentication and selective security configuration procedure for each network slice associated with a (local) HSS operating in the 5G new core network which accommodates the concept of network slicing shown in FIG. 14.

Also, FIG. 17 assumes that a (local) HSS exists for each CNI in addition to the MNO HSS storing subscriber information of the UE (or a 5G new core network entity corresponding to the HSS), and an interface is defined between the CNI and the (local) HSS.

In other words, CNIs are connected to the (local) HSS respectively, and the CNIs do not necessarily pass the C-CPF to obtain information maintained by the HSS.

With reference to FIG. 17, the UE transmits a network connection request message to establish a connection to the operator network (CNIs) S1701.

The network connection request message is delivered to the NNSF (Network Slice Selection Function)/CPSF (C-Plane Selection Function) through a RAN node S1701.

If the UE provides information about a specific CNI and CPF (Control Plane Function) of the CNI to the RAN node, the network connection request message may be delivered directly to the CPF of the specific CNI from the UE.

In other words, the UE is informed of the CNI corresponding to the service that the UE itself wants to receive and may include information related to the CNI (for example, network slice ID, application ID, and service descriptor) in the network connection request message.

Afterwards, the NNSF/CPSF determines the CNI to which the UE is to be connected and CPF of the corresponding CNI according to the information included in the network connection request message that the UE has requested S1702.

In the case of FIG. 17, it may be seen that the CNI included in the network connection request message by the UE is CPF #1.

Afterwards, the NNSF/CPSF delivers information about the CPF (CPF #1) of the CNI to the RAN node S1703.

Afterwards, the RAN node selects the CPF of the CNI according to the response from the NNSF/CPSF S1704.

Although one example of the RAN node may be an eNB, but the present invention is not limited to the aforementioned example.

The RAN node delivers a network connection request message of the UE to the C-CPF (C-CPF-1 of FIG. 17) S1705, where the network connection request message incudes an indicator indicating that the message is a request from the UE for connection to the CNI #1.

In other words, the network connection request of the UE is used for requesting a connection to the service provided by the CNI-1 and include an indicator or indication information for the connection.

Afterwards, the C-CPF identifies a service connection target CNI (CNI #1) of the UE included in the network connection request and delivers a service authentication request for the corresponding UE to the CPF (CPF #1) of the corresponding CNI S1706.

Afterwards, the UE and the CPF of the CNI-1 perform the authentication procedure for connection to the CNI-1 S1707.

Through the process above, the UE and the CNI-1 may respectively generate a seed key for generating a key to the access interval to be used by the UE and the RAN node.

Next, after service authentication for the UE is completed, the CPF of the CNI-1 delivers an authentication response to the C-CPF S1708.

The authentication response message may include information about a seed key for generating a key to be used for the access interval generated by the CNI-1 CPF between the UE and the RAN node and security attributes that may be applied to the CNI-1 UPF-1.

Afterwards, the C-CPF receives the authentication response message and delivers a network connection accept message indicating acceptance of a connection to the CNI-1 to the RAN node S1709.

The network connection accept message may include the information that the C-CPF receives from the CNI-1 CPF at the S1708 step (a seed key for generating a key to be used for the access interval generated by the CNI-1 CPF between the UE and the RAN node and security attributes that may be applied to the CNI-1 UPF-1).

Afterwards, the RAN node and the UE respectively generates a key to be used in the access interval S1710.

During the aforementioned process, the security capability information of the UE may be delivered to the RAN node, and the information about the security attributes that may be applied to the CNI-1 UPF-1 that the RAN node receives at the S1709 step may be delivered to the UE from the RAN node.

The information described above is exchanged between the UE and the RAN node to inform the UE of the security setting that may be applied to the characteristics of the service provided by the CNI-1 so that the algorithm for encryption/integrity between the UE and the CNI-1 may be modified or information about an applicable key size and so on may be adjusted.

In other words, the encryption/integrity algorithm to be applied for provision of a service or information about a key size may be delivered to the UE according to the security capability received from the UE by the RAN node.

Afterwards, the UE delivers a request for a communication service (which indicates service #1 provided by the CNI #1) to the RAN node S1711.

Afterwards, the RAN node delivers the communication service request of the UE to the C-CPF, and the C-CPF delivers the communication service request to the CPF corresponding to the CNI-1 (for example, CPF of CNI-1) S1712.

Next, after session configuration for the UE is completed, the CPF of the CNI-1 delivers a session response to the C-CPF, and the C-CPF delivers the session response to the RAN node S1713.

Next, the Ran node delivers the received session response to the UE S1714.

If the UE and the specific CNI-CPF authenticates each other successfully, the corresponding UE and the CNI-CPF may generate a seed key for generating keys to be used for a service in the access interval.

The generated seed key is delivered to the RAN node by the CNI-1 CPF, and the RAN node and the UE may respectively generate a key for the access interval from the corresponding seed key.

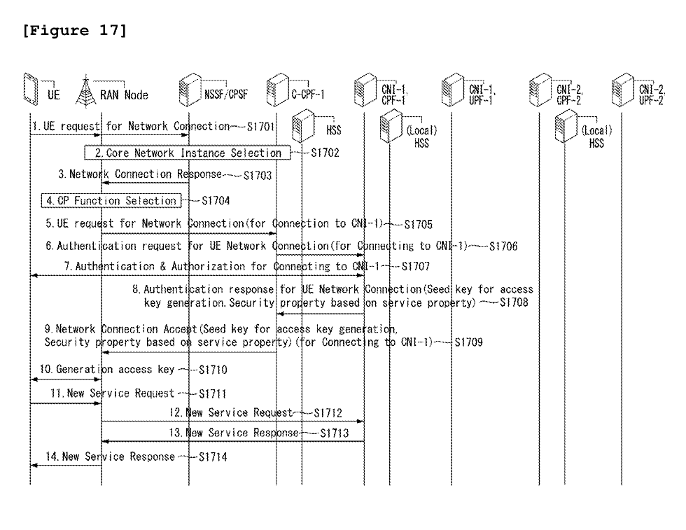

FIG. 18 is a flow diagram illustrating another example of an authentication and selective security setting method for each HSS-based service according to the present invention.

With reference to FIG. 18, a wireless communication system to which a method according to the present invention may be applied includes a UE, RAN node, NSSF/CPSF, C-CPF, HSS, (local) HSS, and one or more CNIs (CPFs, UPFs).

As shown in FIG. 14, FIG. 18 assumes that a plurality of CNIs share a common (or one) C-CPFs.

In this case, selection of a network segment (or slice) may be performed through an application ID (IDentity) and service descriptor (for example, eMBB, CriC, and mMTC) provided by a UE or may be performed through subscriber information of the UE managed by the network (for example, HSS of the LTE system).

FIG. 18 illustrates one example of service authentication and selective security configuration procedure for each network slice associated with a (local) HSS operating in the 5G new core network which accommodates the concept of network slicing shown in FIG. 14.

Also, FIG. 18 assumes that a (local) HSS exists for each CNI in addition to the MNO HSS storing subscriber information of the UE (or a 5G new core network entity corresponding to the HSS), and an interface is defined between the CNI and the (local) HSS.

In other words, CNIs are connected to the (local) HSS respectively, and the CNIs do not necessarily pass the C-CPF to obtain information maintained by the HSS.

Since the S1801 to S1805 steps of FIG. 18 are the same as the S1701 to S1705 steps of FIG. 17, FIG. 17 may be consulted for detailed descriptions; hereinafter, only those parts of FIG. 18 exhibiting a difference from those of FIG. 17 will be described.

After the S1805 step, the UE and the CPF of the CNI-1 perform an authentication procedure for connection to the CNI-1 S1806.

Through the process above, the UE and the CNI-1 may respectively generate a seed key for generating a key to the access interval to be used by the UE and the RAN node.

Next, after service authentication about the UE is completed, CPF of the CNI-1 delivers a network connection accept message indicating acceptance of a connection to the CNI-1 to the C-CPF S1807.

The network connection accept message may include information about a seed key for generating a key to be used for the access interval generated by the CNI-1 CPF between the UE and the RAN node and security attributes that may be applied to the CNI-1 UPF-1.

The C-CPF delivers the received network connection accept message directly to the RAN node.

Afterwards, the RAN node and the UE generate keys to be used in the access interval respectively S1808.

During the aforementioned process, the security capability information of the UE may be delivered to the RAN node, and the information about the security attributes that may be applied to the CNI-1 UPF-1 that the RAN node receives at the S1709 step may be delivered to the UE from the RAN node.

The information described above is exchanged between the UE and the RAN node to inform the UE of the security setting that may be applied to the characteristics of the service provided by the CNI-1 so that the algorithm for encryption/integrity between the UE and the CNI-1 may be modified or information about an applicable key size and so on may be adjusted.

In other words, the encryption/integrity algorithm to be applied for provision of a service or information about a key size may be delivered to the UE according to the security capability received from the UE by the RAN node.

Afterwards, the UE delivers a request for a communication service (which indicates service #1 provided by the CNI #1) to the RAN node S1809.

Afterwards, the RAN node delivers the communication service request of the UE to the C-CPF, and the C-CPF delivers the communication service request to the CPF corresponding to the CNI-1 (for example, CPF of CNI-1) S1810.

Next, after session configuration for the UE is completed, the CPF of the CNI-1 delivers a session response to the C-CPF, and the C-CPF delivers the session response to the RAN node S1811.

Next, the Ran node delivers the received session response to the UE S1812.

### Third Embodiment

In the case of the third embodiment, while performing a connection request of the UE, the C-CPF makes the HSS generate a CNI-specific key to be used for service authentication by individual CNIs from the result of the authentication procedure for network access.

And the C-CPF makes the HSS deliver the generated CNI-specific key to CNIs; and the CPFs of a CNI perform service authentication for CNI connection (session configuration) by using the CNI-specific key received from the HSS during the session configuration process in conjunction with the UE and generate a key for the access interval.

Similarly, while the HSS maintains/manages a CNI-specific key that the HSS itself has generated, CPFs of the CNI request a CNI-specific key from the HSS during the session configuration process in conjunction with the UE, performs service authentication for CNI connection (session configuration) by using the CNI-specific key, and generates a key for the access interval.

During the process above, the CNI and the UE may adjust various security attributes according to service characteristics provided by the corresponding CNI.

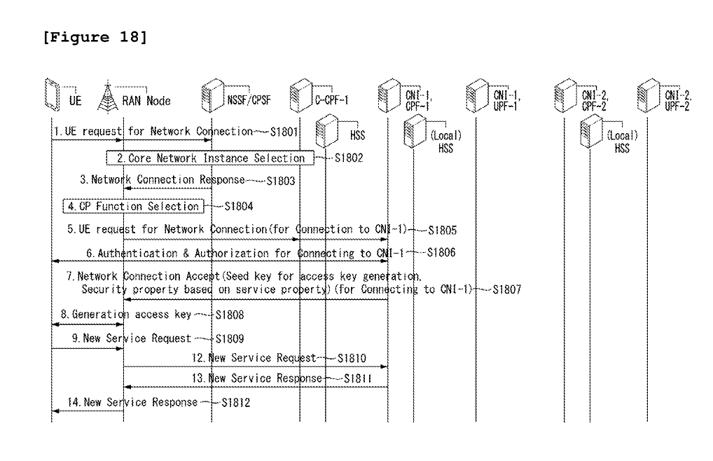

FIG. 19 is a flow diagram illustrating a yet another example of an authentication and selective security setting method for each HSS-based service according to the present invention.

With reference to FIG. 19, a wireless communication system to which a method according to the present invention may be applied includes a UE, RAN node, NSSF/CPSF, C-CPF, HSS, and one or more CNIs (CPFs, UPFs).

As shown in FIG. 14, FIG. 19 assumes that a plurality of CNIs share a common (or one) C-CPFs.

In this case, selection of a network segment (or slice) may be performed through an application ID (IDentity) and service descriptor (for example, eMBB, CriC, and mMTC) provided by a UE or may be performed through subscriber information of the UE managed by the network (for example, HSS of the LTE system).

FIG. 19 illustrates one example of service authentication and selective security configuration procedure for each network slice associated with an HSS operating in the 5G new core network which accommodates the concept of network slicing shown in FIG. 14.

Also, FIG. 19 assumes that an interface is defined between the HSS which stores subscriber information of the UE (or a 5G new core network entity corresponding to the HSS) and the C-CPF (Common CPF), and an interface is defined between the HSS and CNIs.

In other words, CNIs are connected to the HSS respectively, and the CNIs do not necessarily pass the C-CPF to obtain information maintained by the HSS.

With reference to FIG. 19, the UE transmits a network connection request message to establish a connection to the operator network (CNIs) S1901.

The network connection request message is delivered to the NNSF (Network Slice Selection Function)/CPSF (C-Plane Selection Function) through a RAN node S1901.

If the UE provides information about a specific CNI and CPF (Control Plane Function) of the CNI to the RAN node, the network connection request message may be delivered directly to the CPF of the specific CNI from the UE.

Afterwards, the NNSF/CPSF determines the CNI to which the UE is to be connected and CPF of the corresponding CNI according to the information included in the network connection request message that the UE has requested S1902.

In the case of FIG. 19, it may be seen that the CNI included in the network connection request message by the UE is CPF #1.

Afterwards, the NNSF/CPSF delivers information about the CPF (CPF #1) of the CNI to the RAN node S1903.

Afterwards, the RAN node selects the CPF of the CNI according to the response from the NNSF/CPSF S1904.

Although one example of the RAN node may be an eNB, but the present invention is not limited to the aforementioned example.

The RAN node delivers a network connection request message of the UE to the C-CPF (C-CPF-1 of FIG. 19) S1905, where the network connection request message is a request from the UE for connection to the CNI #1.

In other words, the network connection request message is a request to receive authorization to use a common control function provided by the network.

The C-CPF perform authentication for connecting the UE to the CNI-1 S1906.

Afterwards, the HSS which has received a request for authentication-related information about the UE in response to the network connection request of the UE from the C-CPF generates a CNI-specific (sub-master) key to be used for service authentication of the UE for each CNI to which the UE is subscribed according to the subscription information of the UE S1907.

The CNI-specific (sub-master) key may be a key generated by applying a one-way hash function with respect to Ki of the 4G system (for example, KDF (Ki, network slice—ID) or a key generated by applying a one-way hash function with respect to a unique master key corresponding to Ki (for example, KDF (master key, network slice—ID unique to the 5G system corresponding to Ki)) in the case of the 5G system.

Afterwards, the HSS delivers the CNI-specific key generated for each CNI to the CPF of the corresponding CNI S1908.

In other words, the C-CPF may generate CNI-specific keys for all of the CNIs (CNI #1, CNI #2) of the corresponding UE according to the subscriber information of the UE and deliver the generated keys to the CPFs of the respective CNIs.

Afterwards, the UE delivers a request for a communication service (which indicates service #1 provided by the CNI #1) to the RAN node S1909.

At this point, the UE is informed of the CNI of the service requested by itself and may generate a CNI-specific sub-master key by using the ID of the corresponding CNI according to the method described in the S1907 step.

The request for a communication service to the CNI-1 may include security capability information of the corresponding UE.

The security capability information of the UE is included to modify the algorithm for encryption/integrity between the UE and the CNI-1 or to adjust a supported key size.

Afterwards, the RAN node delivers a communication service request of the UE to the C-CPF, and the C-CPF delivers the communication service request to the CPF corresponding to the CNI-1 (for example, CPF of the CNI-1) S1910.

Afterwards, the UE and the CPF of the CNI-1 perform an authentication procedure for connection to the CNI-1 S1911.

Through the process above, the UE and the CNI-1 may respectively generate a seed key (KeNB in the case of the 4G system and a key corresponding to the KeNB in the case of the 5G system) for generating a key to the access interval to be used by the UE and the RAN node.

Afterwards, after authentication of the UE and session configuration are completed successfully, the CPF of the CNI-1 delivers a session response to the C-CPF, and the C-CPF delivers the session response to the RAN node S1912.

The session response may include a seed key for generating a key to be used in the access interval generated by the CPF of the CNI-1 between the UE and the RAN node; and information about security attributes that may be applied to CNI-1 UPF-1.

The seed key is delivered to the RAN node to generate a key to be used in the access interval through interactions (for example, AS security command in the case of the 4G system and a procedure corresponding to AS security command of the 4G system in the case of the 5G system) between the RAN node which has received the seed key and the UE.

Meanwhile, information related to security attributes according to service characteristics is included to inform the UE of the security setting which may be applied according to the characteristics of the service provided by the CNI-1.

Information about encryption/integrity algorithm aimed to be applied for providing a service according to the security capability received by the CNI-1 from the UE or key size may also be included in the security attributes.

Afterwards, the RAN node delivers the received session response to the UE S1913.

At this time, the RAN node exclude the seed key received from the CNI-CPF via the C-CPF and sends only the remaining information (for example, security attributes according to service characteristics).

If the UE and a specific CNI CPF successfully authenticate each other by using a sub-master key through the session request/session response, the corresponding UE and the CNI-CPF may generate a seed key for generating keys to be actually used for a service in the access interval.

The generated seed key is delivered to the RAN node by the CNI-CPF, and the corresponding RAN node and the UE may generate a key for the access interval respectively from the seed key.

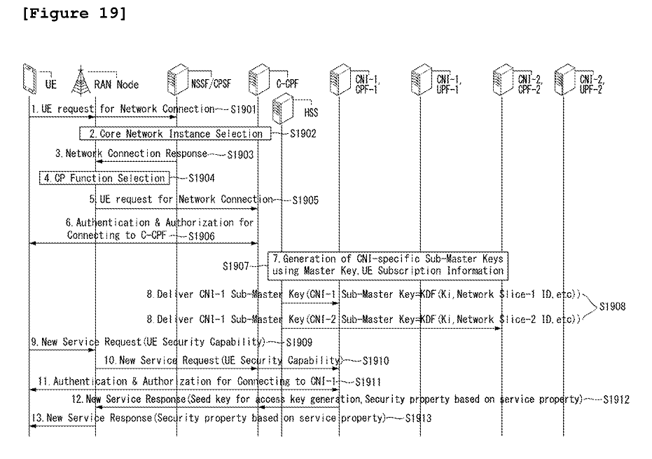

FIG. 20 is a flow diagram illustrating a still another example of an authentication and selective security setting method for each HSS-based service according to the present invention.

In other words, FIG. 20 illustrates another example of service authentication for each network slice and a selective security setting procedure of the present invention according to the 5G new core network architecture which accommodates the concept of network slicing of FIG. 14.

Also it is assumed that an interface is defined between the HSS which stores subscriber information of the UE (or an entity of the 5G new core network corresponding to the HSS) and the C-CPF (Common CPF), and an interface is defined between the HSS and the CNIs.

In other words, CNIs are connected to the HSS respectively, and the CNIs do not necessarily pass the C-CPF to obtain information maintained by the HSS.

Since the S2001 to S2007 steps of FIG. 20 are the same as the S1901 to S1907 steps of FIG. 19, FIG. 19 may be consulted for detailed descriptions; hereinafter, only those parts of FIG. 20 exhibiting a difference from those of FIG. 19 will be described.

With reference to FIG. 20, after the S2007 step, the UE delivers a request for a communication service (which indicates service #1 provided by the CNI #1) to the RAN node S2008.

At this point, the UE is informed of the CNI of the service requested by itself and may generate a CNI-specific sub-master key by using the ID of the corresponding CNI according to the method described in the S2007 step.

The request for a communication service to the CNI-1 may include security capability information of the corresponding UE.

The security capability information of the UE is included to modify the algorithm for encryption/integrity between the UE and the CNI-1 or to adjust a supported key size.

Afterwards, the RAN node delivers a communication service request of the UE to the C-CPF, and the C-CPF delivers the communication service request to the CPF corresponding to the CNI-1 (for example, CPF of the CNI-1) S2009.

Afterwards, the CPF corresponding to the CNI-1 delivers a key request including the information about the identifier of the UE which has requested the CPF itself to establish a session to the HSS S2010.

The above operation is intended to obtain a CNI-specific key for each CNI generated by the C-CPF.

Afterwards, in response to the request of the CNI-1 CPF, the HSS delivers a key response including the CNI-specific key generated for the CNI with respect to the corresponding UE S2011.

Afterwards, the UE and the CPF of the CNI-1 perform an authentication procedure for connection to the CNI-1 S2012.

Through the process described above, the UE and the CNI-1 may respectively generate a seed key (KeNB in the case of the 4G system and a key corresponding to the KeNB in the case of the 5G system) for generating a key for the access interval to be used by the UE and the RAN node.

Afterwards, after authentication of the UE and session configuration are completed successfully, the CPF of the CNI-1 delivers a session response to the C-CPF, and the C-CPF delivers the session response to the RAN node S2013.

The session response may include a seed key for generating a key to be used in the access interval generated by the CPF of the CNI-1 between the UE and the RAN node; and information about security attributes that may be applied to CNI-1 UPF-1.

The seed key is delivered to the RAN node to generate a key to be used in the access interval through interactions (for example, AS security command in the case of the 4G system and a procedure corresponding to AS security command of the 4G system in the case of the 5G system) between the RAN node which has received the seed key and the UE.

Meanwhile, information related to security attributes according to service characteristics is included to inform the UE of the security setting which may be applied according to the characteristics of the service provided by the CNI-1.

Information about encryption/integrity algorithm aimed to be applied for providing a service according to the security capability received by the CNI-1 from the UE or key size may also be included in the security attributes.

Afterwards, the RAN node delivers the received session response (message) to the UE S2014.

At this time, the RAN node exclude the seed key received from the CNI-CPF via the C-CPF and sends only the remaining information (for example, security attributes according to service characteristics).

If the UE and a specific CNI CPF successfully authenticate each other by using a sub-master key through the session request/session response, the corresponding UE and the CNI-CPF may generate a seed key for generating keys to be actually used for a service in the access interval.

The generated seed key is delivered to the RAN node by the CNI-CPF, and the corresponding RAN node and the UE may generate a key for the access interval respectively from the seed key.

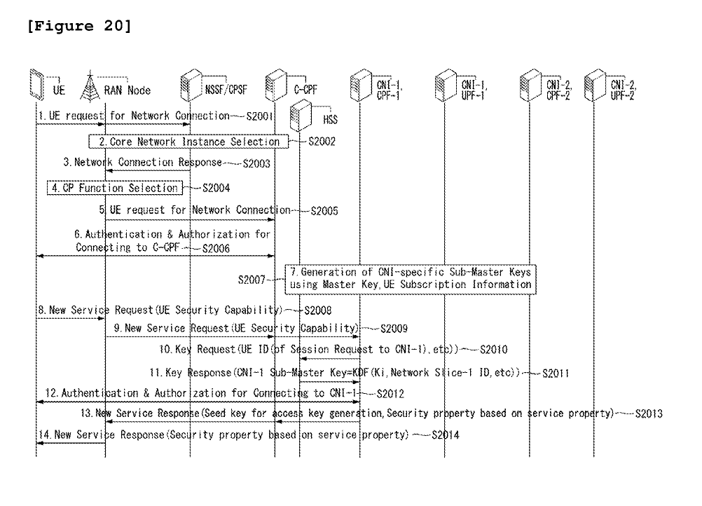

FIG. 21 is a flow diagram illustrating one example of an authentication and selective security setting method for each service according to the present invention.

First, a first network node performs an authentication procedure in conjunction with the UE S2110.

The S2110 step corresponds to an authentication procedure for connecting a UE to the first network node.

The first network node is an entity having a common control function and may indicate the C-CPF described above.

Afterwards, the first network node obtains at least one security key corresponding to each of at least one second network node of the core network S2120.

The at least one security key may be generated according to the result of the authentication procedure.

At this time, the obtaining the at least one security key may include the concept of generating the at least one security key.

The second network node may indicate a core network instance (CNI) described above.

Also, the security key may be generated according to a one-way hash function and may correspond to a CNI-specific (sub-master) key.

Also, the at least one security key may be generated by a third network node according to the subscriber information of the UE.

In this case, the at least one security key may be received from the third network node.

The third network node may be an HSS (Home Subscriber Server).

Also, the at least one second network node provides a separate service.

Afterwards, the first network node transmits the obtained (or generated) at least one security key to each of the at least one second network node S2130.

Before the S2110 step, the first network node may receive a first message in response to the UE's connection request to the core network from a RAN (Radio Access Network) node.

At this time, the first message may correspond to the network connection request message described above.

After the S2130 step, the following procedures may be performed additionally.

In other words, the first network node may receive a second message in response to the UE's communication service request from the RAN node.

And the first network node may transmit the received second message to a specific second network node corresponding to the communication service request.

Also, the first network node may receive a response message with respect to the communication service request from the specific second network node.

The response message may include at least one of a seed key for generating a key used in the access interval between the UE and the RAN node and the security attribute information applied to the specific second network node.

Also, the security attribute information may be applied to the entity which performs the user plane function of the specific second network node.

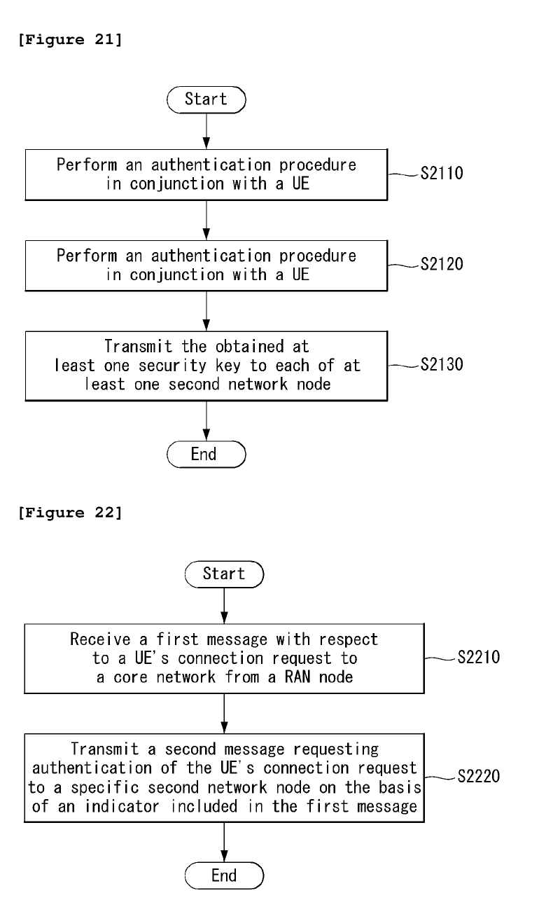

FIG. 22 is a flow diagram illustrating another example of an authentication and selective security setting method for each service according to the present invention.

First, a first network node receives a first message in response to the UE's connection request to the core network from the RAN (Radio Access Network) node S2210.

The first network node is an entity having a common control function and may indicate the C-CPF described above.

The first message may include an indicator indicating that the UE's connection request requests a connection to a specific second network node of the core network.

The first message may be a network connection request message.

Afterwards, the first network node transmits a second message for requesting authentication of the UE's connection request to the specific second network node on the basis of the indicator included in the first message.

The second node may indicate the core network instance (CNI) described above.

The second message may be an authentication message.

After the S2220 step, the following procedures may be performed additionally.

In other words, the first network node may receive a response message with respect to the second message from the specific second network node.

The response message may include at least one of a seed key for generating a key used in the access interval between the UE and the RAN node and the security attribute information applied to the specific second network node.

The security attribute information may be applied to the entity which performs the user plane function of the specific second network node.

After receiving the response message, the first network node may receive a third message with respect to the communication service request of the UE from the RAN node.

At this time, the communication service indicates a service provided by the specific second network node.

Also, the third message may be a new service request message.

Afterwards, the first network node may transmit the received third message to the specific second network node corresponding to the communication service request.

Also, the first network node may receive a response with respect to the communication service request from the specific second network node.

The response with respect to the communication service request may be a new service response message.

Apparatus to which the Present Invention may be Applied

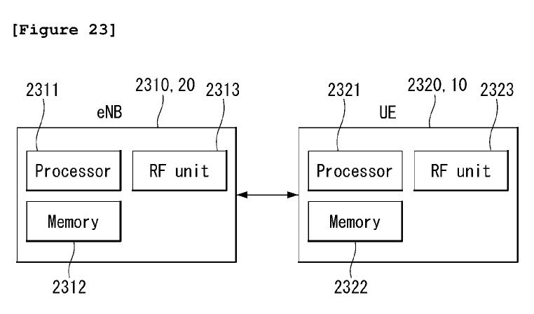

FIG. 23 is a block diagram of a wireless communication apparatus to which methods according to the present invention may be applied.

With reference to FIG. 23, a wireless communication system comprises an eNB 2310 and a plurality of UEs 2220 located within the communication range of the eNB 2310.

The eNB 2310 includes a processor 2311, a memory 2312, and an RF (Radio Frequency) unit 2313. The processor 2311 implements functions, processes and/or methods proposed in FIG. 1 to FIG. 22. The layers of a wireless interface protocol may be implemented by the processor 2311.

The memory 2312 is connected to the processor 2311 and stores various information for driving the processor 2311. The RF unit 2313 is connected to the processor 2311 and transmits and/or receives radio signals.

The UE 2320 includes a processor 2321, a memory 2322, and an RF (Radio Frequency) unit 2323.

The processor 2321 implements functions, processes and/or methods proposed in FIG. 1 to FIG. 22. The layers of a wireless interface protocol may be implemented by the processor 2321. The memory 2322 is connected to the processor 2321 and stores various information for driving the processor 2321. The RF unit 2323 is connected to the processor 2321 and transmits and/or receives radio signals.

The memory 2312, 2322 may be located inside or outside the processor 2311, 2321, and may be coupled to the processor 2311, 2321 by using various well-known means.

Also, the eNB 2310 and/or UE 2320 may have a single or multiple antennas.

The embodiments described above are combinations of constituting elements and characteristics of the present invention in a predetermined manner. Each individual constituting element or characteristic has to be considered to be selective unless otherwise explicitly stated. Each individual constituting element or characteristic may be implemented so that it is not combined with other constituting elements or characteristics. Also, the embodiment of the present invention may be implemented by combining part of the constituting elements and/or characteristics. The order of operations described in the embodiments of the present invention may be changed. Part of the structure or characteristics of one embodiment may be included in a different embodiment or replaced with the corresponding structure or characteristics of the different embodiment. It is apparent that an embodiment may be constructed by combining those claims not explicitly referencing to each other within the technical scope of the present invention or included as a new claim by amendment after patent application.

The embodiments of the present invention may be implemented by various means, for example, hardware, firmware, software, or a combination thereof. In the case of hardware implementation, one embodiment of the present invention may be implemented by one or more of ASICs (Application Specific Integrated Circuits), DSPs (Digital Signal Processors), DSPDs (Digital Signal Processing Devices), PLDs (Programmable Logic Devices), FPGAs (Field Programmable Gate Arrays), processor, controller, micro-controller, and micro-processor.

In the case of software implementation, one embodiment of the present invention may be implemented in the form of a module, procedure, or function which performs the function or operations described above. Software codes may be executed by a processor stored in the memory. The memory may be located inside or outside the processor and may exchange data with the processor by using already-known various means.

It should be clearly understood by those skilled in the art that the present invention may be embodied in a different specific form as long as the embodiment does not lose essential characteristics of the present invention. Therefore, the detailed descriptions above may not be interpreted as limiting the present invention in any aspects but should be regarded as being illustrative. The technical scope of the present invention should be determined according to rational interpretation of appended claims, and all changes within the equivalent scope of the present invention should be included in the technical scope of the present invention.

### INDUSTRIAL APPLICABILITY

A method for performing security setting for a UE in a wireless communication system according to the present invention has been described with an example applied to the 5G system, but the present invention may also be applied to various wireless communication systems such as the 3GPP LTE/LTE-A system.

What is claimed is:

1. A method for performing authentication of a User Equipment (UE) for individual services in a wireless communication system, performed by a first network node providing a common control function, comprising:
receiving from a RAN (Radio Access Network) node a first message with respect to the UE's request to connect to a core network; and
transmitting a second message for requesting authentication of the UE's connection request to a specific second network node on the basis of an indicator included in the first message,
wherein the first message includes an indicator indicating that the connection request of the UE requests connection to the specific second network node of the core network.

2. The method of claim 1, further comprising receiving a response message with respect to the second message from the specific second network node.

3. The method of claim 2, wherein the response message includes at least one of a seed key for generating a key used in an access interval between the UE and the RAN node or security attribute information applied to the specific second network node.

4. The method of claim 3, wherein the security attribute information is applied to an entity performing a user plane function of the specific second network node.

5. The method of claim 1, further comprising
receiving a third message with respect to a communication service request of the UE from the RAN node; and
transmitting the received third message to the specific second network node corresponding to the communication service request.

6. The method of claim 5, further comprising receiving a response with respect to the communication service request from the specific second network node.

7. The method of claim 5, wherein the communication service is provided by the specific second network node.

8. The method of claim 1, wherein the second network node is a Core Network Instance (CNI).

9. An apparatus performing a common control function in a wireless communication system, comprising:
an RF (Radio Frequency) unit transmitting and receiving a radio signal; and
a processor functionally connected to the RF unit,
wherein the processor is configured
to receive a first message with respect to a UE's request to connect to a core network from a RAN (Radio Access Network) node; and
to transmit a second message for requesting authentication with respect to the UE's connection request to a specific second network node on the basis of an indicator included in the first message,
wherein the first message includes an indicator indicating that the connection request of the UE requests connection to the specific second network node of the core network.

10. The apparatus of claim 9, wherein the processor is configured to receive a response message with respect to the second message from the specific second network node.

11. The apparatus of claim 10, wherein the response message includes at least one of a seed key for generating a key used in an access interval between the UE and the RAN node or security attribute information applied to the specific second network node.
